(19) United States
(12) Patent Application Publication
(10) Pub. No.: US 2012/0011448 A1
(43) Pub. Date: Jan. 12, 2012

(54) Building Email conversations by applying an Atomicity Dissection Method to extract atomic elements embedded in Emails and showing the constructed conversation without loss of conveyed meaning while transmitting conversations in separated units

(76) Inventor: Edward T. Tse, Anaheim, CA (US)

(21) Appl. No.: 12/833,971

(22) Filed: Jul. 10, 2010

(51) Int. Cl. G06F 15/16; G06F 3/01; G06F 17/30

(52) U.S. Cl. 715/752; 709/206; 707/802; 707/E17.044

(57) ABSTRACT

The Email Atomicity Dissection Method disclosed herein suggests an alternate and significantly more advanced view of a collection of Emails. Advancing the basic concept and usage of chronologically ordered emails, this method allows the emails in a multi-dimensional manner. There are two stages in applying this method of building conversations. The first is analyzing the existing emails to build a database of candidates for email conversations and recording the attributes of each email for future matching. The next stage is the ability to analyze incoming emails in real-time.

### CROSS REFERENCE TO RELATED APPLICATIONS

Not Applicable.

### FIELD OF THE DISCLOSURE

The present disclosure relates to a method to build conversations from a group of related emails using the method of atomicity dissection of emails. This method is called Atomicity Dissection Method. (Atomicity is the indivisible element where no further division of email can be performed without loss of meaning.) This concept is applied to building email conversations, grouping related emails, and removing redundant content from emails. This disclosure also exposes another more essential paradigm shift of viewing your inbox. Instead of viewing one's mailbox as a chronological collection of communication contents, it (the mailbox) can also be viewed as a collection of inter-related contents thus providing complex intelligences. The concept and method of extracting related emails and presenting it in a view panel is explained in detail.

### BACKGROUND

1. Field

The present invention relates to email organization and presentation by constructing chains of emails by analyzing for atomic transmission units. The methodology provided therein represents an innovation where the view of one's inbox becomes a multi-dimensional extrusion of intelligence (as opposed to the uni-dimensional view characterized by the chronological order view of a collection of emails).

2. Background

Emails can be the primary source of communication for businesses. With the advancement of modern Email communication technology and fast interne infrastructure, it is inevitable we will be inundated with emails on a daily basis. To this day, emails are considered as a “communication” tool.

In actuality, Emails are like the English alphabet. You use a combination of letters to convey a message, not individual letters. So to have meaningful emails, one must consider a collection of related emails, otherwise, Email communications are degenerated into announcements and advertisements. In order to explain the concept and method in the CLAIM, we classify Emails into three types: Single Transmission Units, Chained Transmission Units, and Subject/Title Connected Transmission Units. These three types of emails are explained in full detail in the DESCRIPTION SECTION.

### SUMMARY

Embodiments of the present invention include a method for identifying emails for the purpose of building conversations and presenting them in a meaningful and comprehensive manner. This method can identify a related email string unequivocally. After the strings have been identified, a method of display is described to show them in an organized panel with the conversation constructed, attributes are well organized and the interaction being fully explained.

The Atomicity Dissection approach disclosed herein addresses the issue of conversation building method and its associated display design.

In this context of invention disclosure, we classify emails into three types: Starter Transmission Units (STU), Chained Transmission Units - using Replies/Forwards and CC's (CTU) and Subject/Title Connected Transmission Units (SCTU). The method of dissection of emails using STU to identify related emails and the SCTU algorithm to construct a composite of conversations is also discussed.

There are two stages in applying this method of building conversations. The first is analyzing the existing emails to build a database of candidates for email conversations and recording the attributes of each email for future matching. The next stage is the ability to analyze incoming emails in real-time.

To provide a naturally efficient viewing panel into such group of classified emails; this claim embodies a special viewing panel. This viewing panel shows the users the emails that are most likely important to the user. Its presentation must be simple in concept, natural and familiar to use, and quick to display. This View Panel is usually hosted in an Email Client such as Microsoft Outlook and is docked as a side panel. Once active, the conversation displayed and its associated attributes are fully synchronized with the mouse events. As a result, if you show the inbox display of the hosting Email Client along with the Conversation View Panel, you will see the full conversational history of the email you are currently viewing. U.S. Patent Documents

| | | |
|---|---|---|
| 5,768,505 | June 1998 | Gilchrist et al. |
| 6,301,245 | October 2001 | Luzeski et al. |
| 2008/0120556 | May 2008 | Bedingfield et al. |

### BRIEF DESCRIPTION OF THE DRAWINGS AND TABLES

The accompanying drawings which are incorporated in and constitute part of the specification, illustrates various embodiments of the invention. Together with the general description, the drawings serve to explain the principles of the invention. In the drawings:

FIG. 1 depicts an exemplary for general attributes of a typical email used in the explained Email Atomicity Dissection method. It is based on four main attribute groups: “From Address”, “Subject Line”, “Date/Time Separator”, “CC: List”, and “Content”.

FIG. 2 depicts an exemplary list of attributes, behaviors and values to properly characterize the Email Atomicity Dissection Method.

FIG. 3 depicts exemplary samples of Emails that are viewed from the Email Client view panel such as Microsoft Outlook.

FIG. 4 depicts an exemplary Viewing Panel for displaying the resulting group of fully constructed Email Conversations and its associated organized attributes.

FIG. 5 depicts an exemplary indicatory region and content to be evaluated as a key to relate them. This is called “Starter Transmission Unit” identification.

FIG. 6A-6E depicts an exemplary conversation being built from the collected groups of related emails employed by the Atomicity Dissection method.

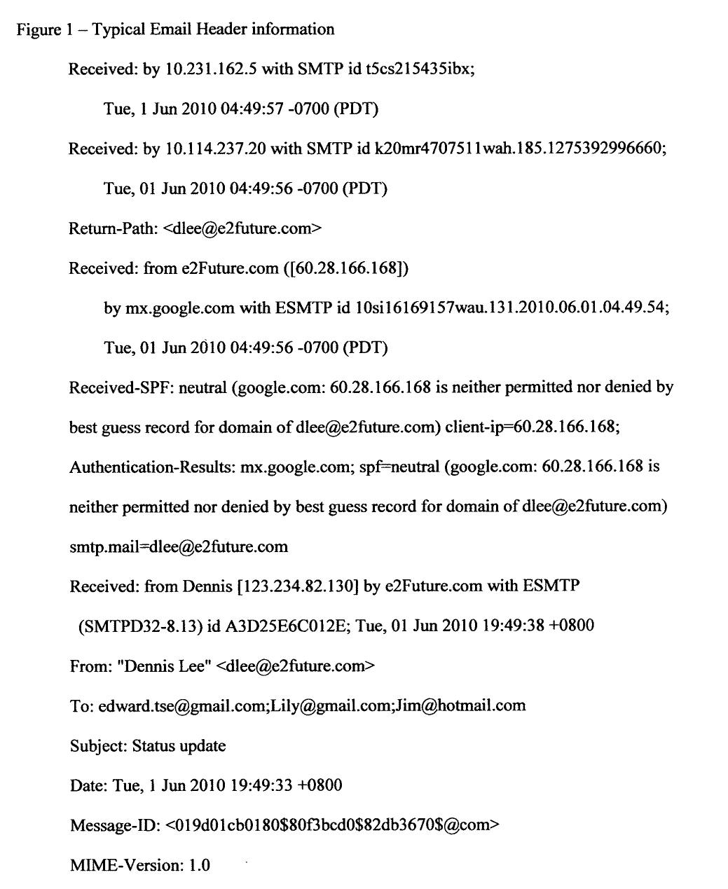

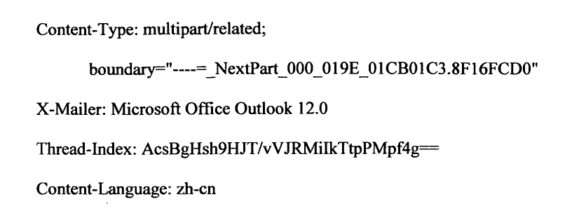

### DETAILED DESCRIPTION

In this context of invention disclosure, we classify emails into three types: Starter Transmission Units (STU), Chained Transmission Units—using Replies/Forward and CC's (CTU) and Subject/Title Connected Transmission Units (SCTU).

STU—When the user creates a “New Message” or “New Email” action in an Email Client, an STU is created. The action also reflects (generally) a new topic, conversation, question or discussion.

CTU—When a “Reply/Forward/CC” action is performed, a CTU is created. This has a distinct characteristic where the email content contains the STU.

SCTU—Emails that share the same Subject/Title content (after the FWD:/RE:/CC: prefix pared) are called SCTUs. Emails with empty Subject/Title content are exceptions and will not be included in this filing.

In addition, once we have carefully assigned the conversational attributes of emails, we can describe the CLAIM in a more specific and focused matter. The following are attributes we define in a Conversation:
a. Subject/Title Line—Standard subject/title line you find in any email. Some Email Clients insert an RE:/FWD:/CC: for Replies, Forwards, or Carbon Copies to indicate that this transmission is in reference to an email or attachment received.
b. Transmission From Address—There is one and only one sender address for each email (in any of the following category STU/CTU/SCTU or body-less or subject-less emails that fall outside of these categories.).
c. Participants—Names or Email addresses that appear in the content of an email are referred to as Participants. They may be recipients directly replied to, sent to or one of the CC: entries.
d. Attachments—Attachments are electronic elements which are transmitted alongside the email. Embedded graphics are not considered to be an attachment.
e. STU Transmission Contents—Email Content is defined to be the text/graphics elements bound between the standard Email and the suffix element such as signature and organization.

What is claimed is:

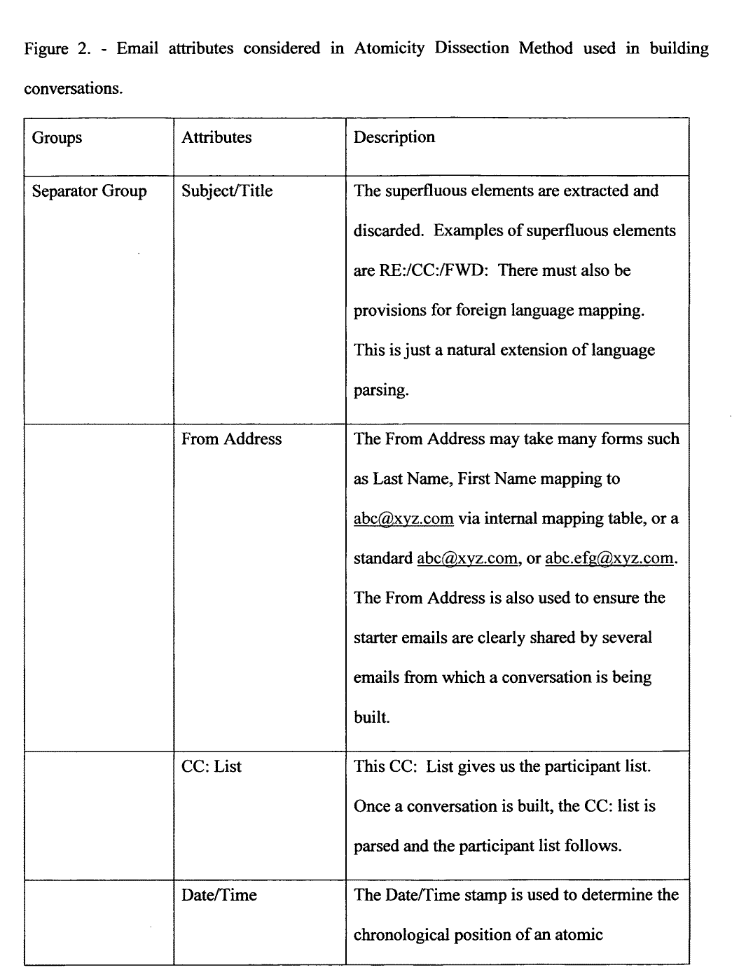

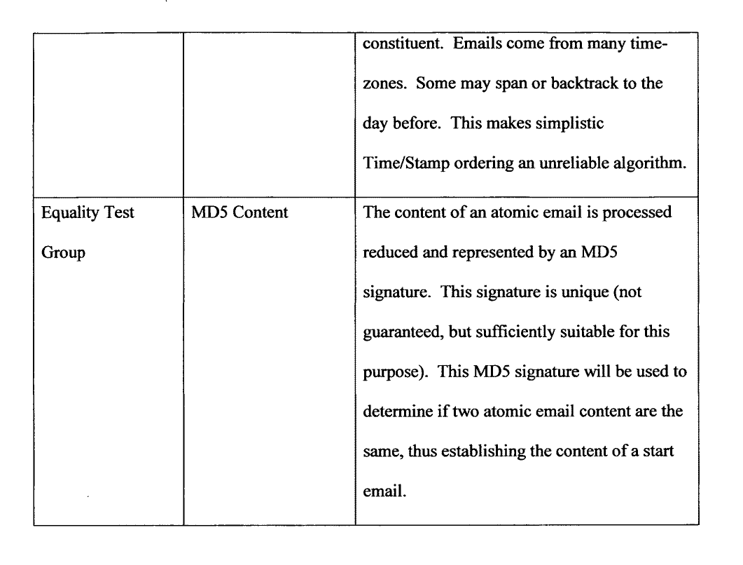

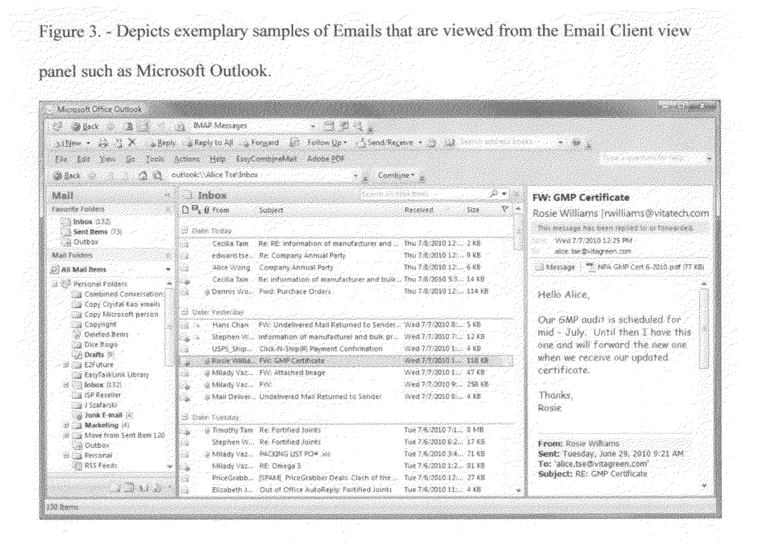

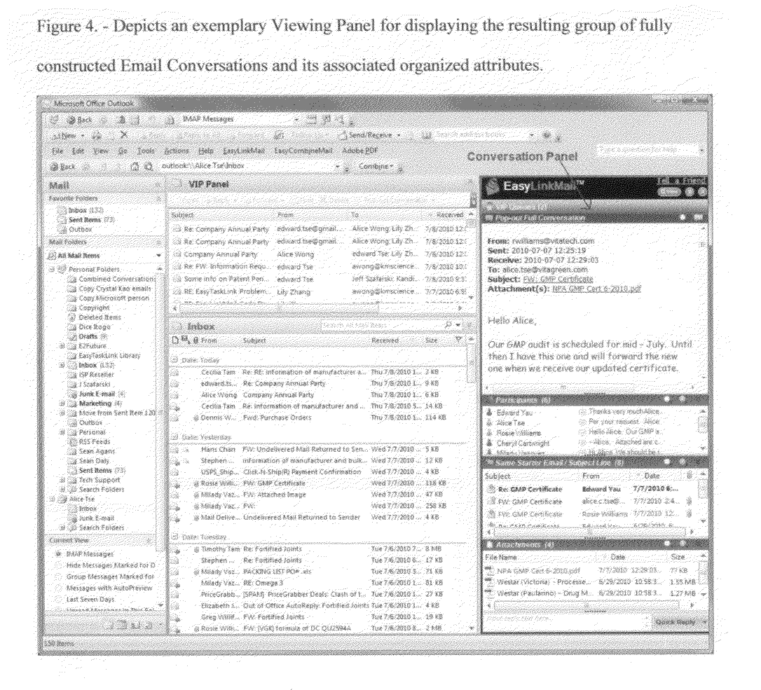

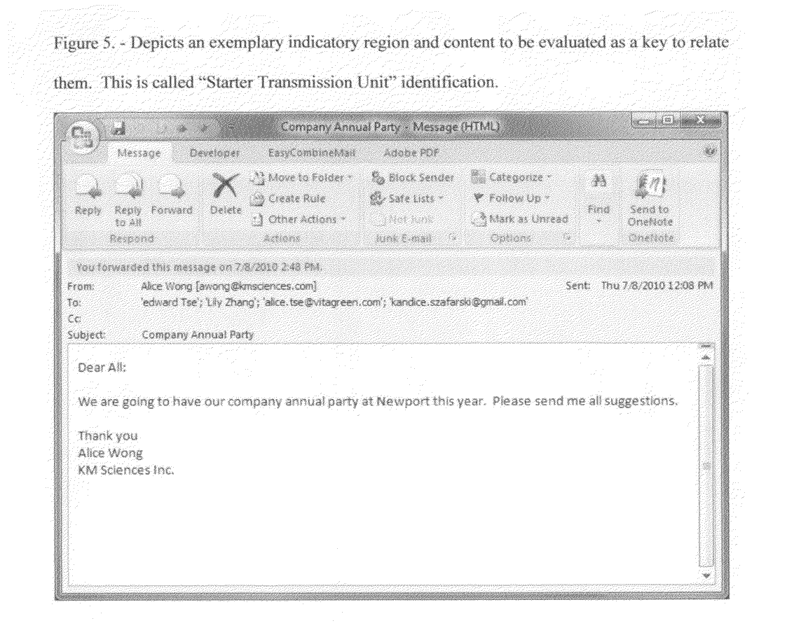

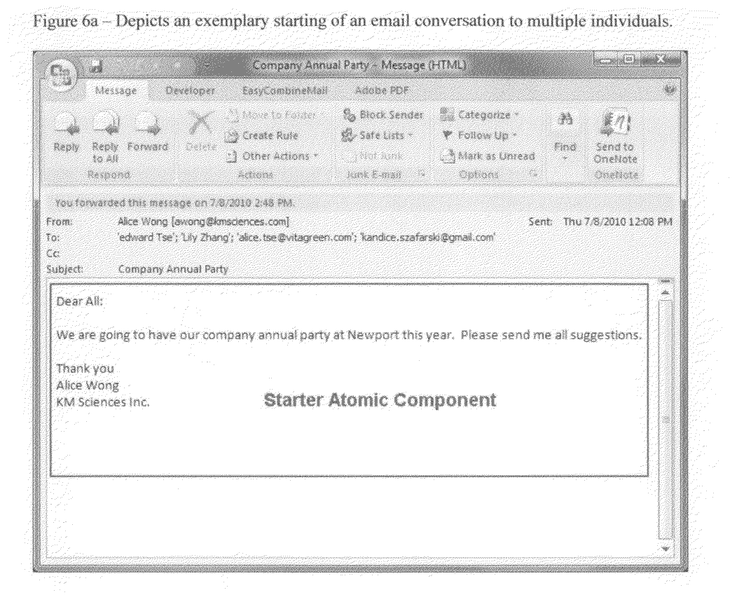

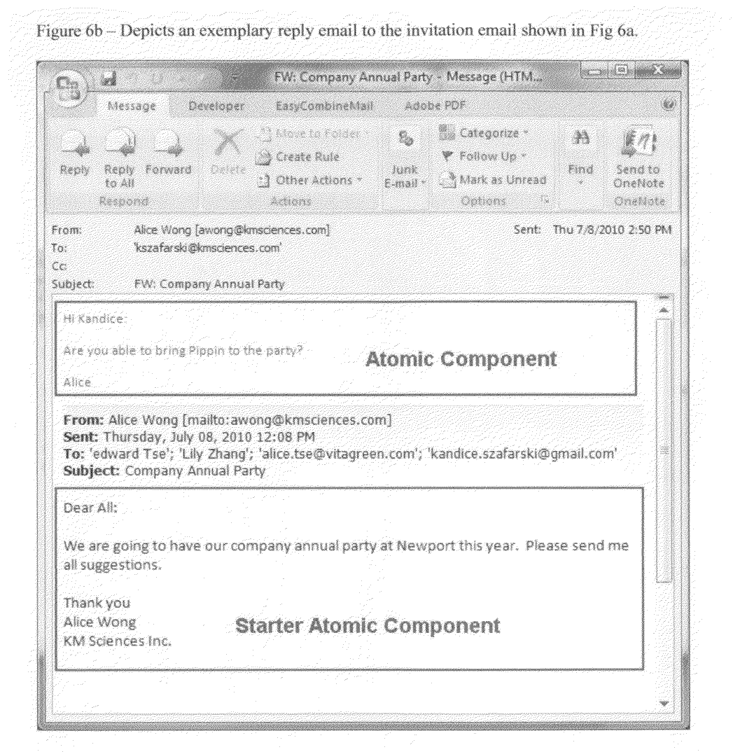

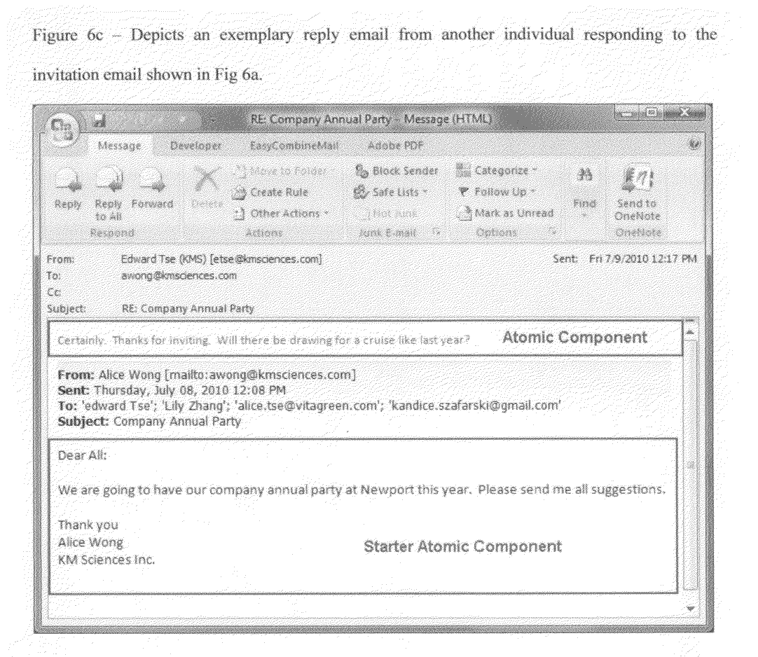

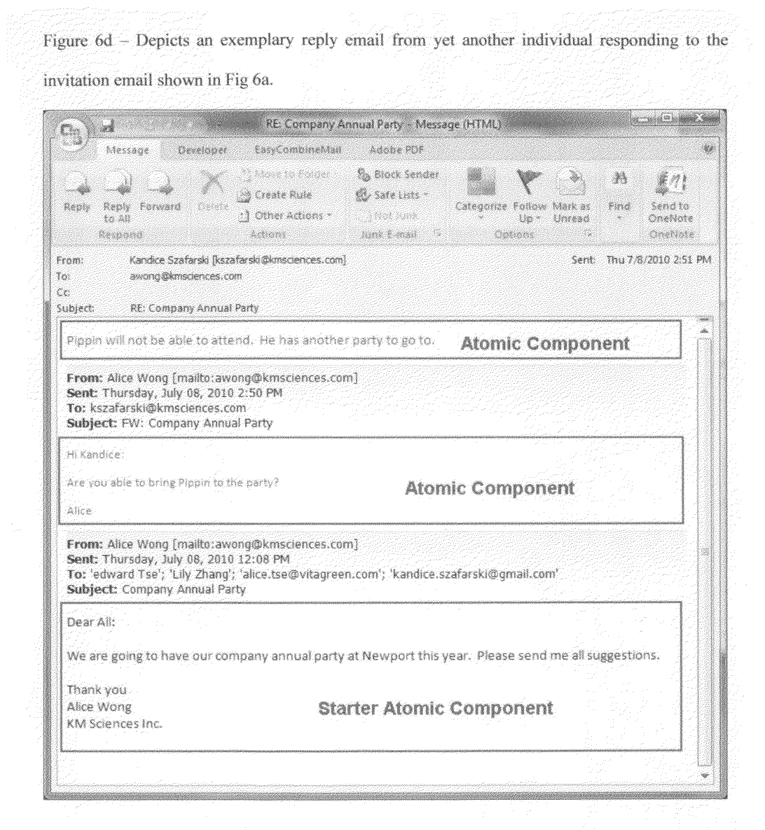

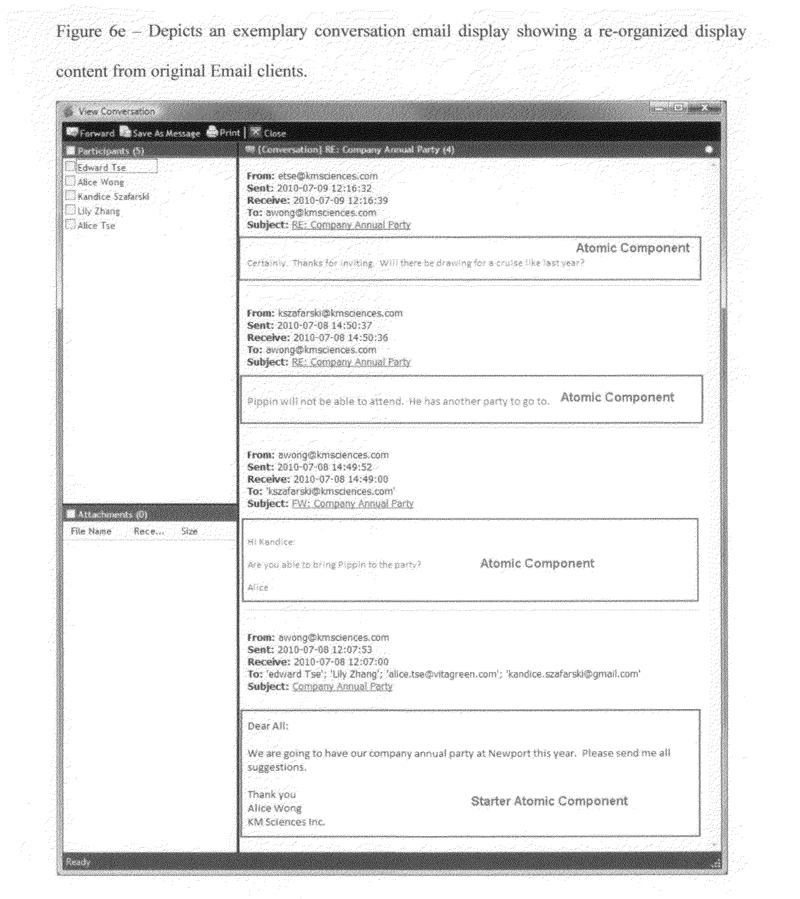

1. A method of dissecting emails into their basic atomic components comprised of defining the separator(s) using the attributes in sequence or their permutations of sequences fully exposed in FIG. 2—Separator Group.

2. The method of claim 1, wherein the resulting atomic component is parsed to eliminate redundancies using the Equality Test Group MD5 (Industry Standard Message Digest 5 Algorithm) (FIG. 2—Equality Test Group) of the component baring footer information such as bitmaps of signatures, company or contact information.

3. The method of claim 1, wherein the resulting atomic component is parsed to eliminate superfluous or artificial text inserted in the subject element of an email such as RE:/FWD:/CC: prefixes to the subject line.

4. The method of claim 1, wherein the resulting atomic component is parsed to remove formatting elements including all html tags, embodiments of inserted images and URL links found.

5. The method of claim 1, wherein the resulting atomic component content is extracted and a standard MD5 signature algorithm is used to uniquely identify and record the atomic content in a local tandem database.

6. The method of claim 1, wherein the resulting atomic component “To Address(es)” are extracted and recorded in the local tandem database.

7. The method of claim 1, wherein the resulting atomic component “Attachment(s)” are extracted and recorded in the local tandem database, and that the link between the STU in which Attachments) is hosted and the attachments are recorded.

8. The method of claim 1, wherein the resulting atomic component “Attachment(s)” date/time of receipt of creation, whether it is the actual modification timestamp or the transmission date/time, are recorded with the hosting email message identification.

9. A method of construction of an all-inclusive sequence of related atomic components in the form of an email such that the original appearance of each parent email where the atomic component within it is fully preserved.

10. The method of claim 9, wherein the format is preserved is accomplished by duplicating the html tags, formatting elements, embedded image URLs, and the style specifications are preserved in the style and header found in the resulting conversation.

11. The method of claim 9, wherein the format is preserved is accomplished by moving the attachments to a location where the newly constructed conversation locates resulting in a display with original formats and images.

12. The method of claim 9, wherein the participants in the resulting atomic component in claim 1 are extracted and kept within the STU found in the conversation's atomic email location.

13. A method of determining if two emails belong to a context related conversation by examining the sender address, content MD5 (as discussed in claim 1)

14. A method of claim 13, wherein the algorithm to determine if two emails are related is based on the steps below.
a. Step 1.—From the resulting atomic components, compare the content MD5 of their Start Units (from their Single Transmission Unit).
b. Step 2.—From the resulting atomic components, compare the “From Address” to ensure composite Emails (SCTU) from two transmissions have the same Start Unit.
c. Step 3.—From the resulting atomic components, compare the “Receipt Date/Time” and ensure composite Emails (SCTU) from two transmissions have the same Start Unit. To be classified as the same Start Unit, two SCTUs must be within one minute apart or less.

15. A software component (a view panel) to show the conversations.
a. Conversation
b. Participants
c. List of Related Emails
d. Locate Email which sends the selected Attachment
e. Condense and Html View Mode

16. This display component of claim 15, where in the contextual elements include a display of the full conversation built based on the related emails selection devised from claim 1.

17. The display component of claim 15, wherein the contextual elements include synchronization of contents displayed in the hosting Email Client and the attributes associated with the email that is currently pointed to by mouse movements.

18. The display component of claim 15, wherein the contextual elements include showing the participants list interpreted in its plurality and extracted by the method of claim 1.

19. The display component of claim 15, wherein the contextual elements include showing the list of constituents related emails that build the conversation.

20. The display component of claim 15, wherein the contextual elements of “Locate Email which sends the selected Attachment” means showing the email which first sends the attachment(s) in its plurality.

21. The display component of claim 15, wherein the contextual element of “List of Related Emits” directly links to the original emails that makes up the conversation.

22. A method to build the conversation in chronological order by assigning sequence number into each atomic email such that if the order sequence of the atomic email orders is preserved (in the order of ascending sequence instead of monotonic constant increment), then the order of the conversation in total will be preserved.

23. The method of claim 22, wherein the Date/Time stamp will only be used to compare “equality” rather than comparing for sequencing.

24. The method of claim 22, wherein the sequence of the atomic emails are in sequence order rather than monotonic increment suffices (1,2,3 . . . is in an ascending monotonic sequence where 1,1,1,2,3,3 . . . are in ascending sequence).

25. The method of claim 22, wherein the sequence of the atomic emails make adequate provision for emails from multiple time-zones and be able to preserve the actual order based on the entry of the system order rather than re-ordered based on timestamps.

26. The method of claim 22, wherein the sequence based on the order or receipt significantly improves or even guarantees the causal relationship between two atomic email components.

27. The method of claim 22, wherein the analysis of the atomic components follows the steps below:
a. Remove html Tags.
b. Use “Subject/From/Date Time stamp” as the separator, build atomic components.
c. Remove Footer information.
d. Assign a sequence number to each atomic component.
e. Record the starter atomic component.
f. Collect all starter atomic components in the collection of target emails.

28. The method of claim 22, wherein the construction of the atomic components follows the steps below:
a. For each composite email, match up with the collection of starter atomic component. Hence created a collection of candidate emails to build a conversation.
b. Pick two emails from the collection, match up their atomic components. This creates spotted matching between the two lists of atomic components. The sequence of any atomic components falling between two matching spots is then preserved in overall sequence regardless of the receiving data/time stamp.
c. For example Email 1 pattern is A4B23C256 and Email 2 pattern is A1C7, then the resulting conversation becomes A41B23C2567.
